(19) United States
(12) Patent Application Publication
(10) Pub. No.: US 2014/0127352 A1
(43) Pub. Date: May 8, 2014

(54) FLAVORED DRINKING WATERS AND METHODS FOR IMPROVING HYDRATION FOR ANIMALS

(71) Applicants: Gary J. Woodward, University City, MO (US); Manjuan Jenny She, Chesterfield, MO (US); Sandra Lynn, St. Louis, MO (US); Claude Lecouteux, St. Louis, MO (US)

(72) Inventors: Gary J. Woodward, University City, MO (US); Manjuan Jenny She, Chesterfield, MO (US); Sandra Lynn, St. Louis, MO (US); Claude Lecouteux, St. Louis, MO (US)

(73) Assignee: NESTEC SA, Vevey (CH)

(21) Appl. No.: 14/070,750

(22) Filed: Nov. 4, 2013

Related U.S. Application Data
(60) Provisional application No. 61/722,391, filed on Nov. 5, 2012.

(51) Int. Cl. A23K 1/175

(52) U.S. Cl. CPC A23K 1/1755
USPC 426/2; 426/534; 426/66

(57) ABSTRACT

The invention provides flavored drinking water additives and flavored drinking water compositions. The invention also provides methods for increasing water consumption by an animal and improving hydration for animals using the flavored drinking water additives and flavored drinking water compositions of the present invention.

### CROSS REFERENCE TO RELATED APPLICATIONS

This application claims priority to U.S. Provisional Application No. 61/722,391 filed Nov. 5, 2012, the disclosure of which is incorporated herein by this reference.

### BACKGROUND OF THE INVENTION

1. Field of the Invention

This invention relates generally to drinking water and hydration and particularly to flavored drinking water additives, flavored drinking water compositions and methods for increasing water consumption and improving hydration for animals, particularly felines.

2. Description of Related Art

Hydration is essential to a cat's health. Water aids in waste elimination, body temperature regulation, and digestion. However, in the wild, they typically derive most of their fluid needs from the prey they consume. Ensuring that a cat has sufficient water intake is a common problem for cat owners. A flavored water additive is a convenient vehicle for enhancing drinking water for cats.

Palatability enhancers for pet food are known in the art. U.S. Pat. Nos. 6,354,920 and 6,350,485 to Brunner disclose the use of tetrasodium pyrophosphate as a palatability enhancer for dry and semi-moist cat food. U.S. Pat. No. 5,186,964 to Gierhart et al. discloses the use of a pyrophosphate salt or an acid phosphate salt as a palatability enhancer for dry pet food. U.S. Pat. No. 7,244,460 to Lee et al. discloses the use of a tripolyphosphate salt as a palatability enhancer for dry and semi-dry pet food. The use of a palatability enhancer as a flavored drinking water additive is novel.

Many pet owners, particularly cat owners, believe their pets do not drink enough water. There is, therefore, a need for new flavored drinking water additives, flavored drinking water compositions and methods for improving hydration for animals

### SUMMARY OF THE INVENTION

It is, therefore, an object of the present invention to provide flavored drinking water additives.

It is another object of the present invention to provide flavored drinking water compositions suitable for consumption by animals.

It is another object of the present invention to provide methods for increasing water consumption by an animal.

It is another object of the present invention to provide methods for improving hydration for animals.

One or more of these and other objects are achieved using flavored drinking water additives and flavored drinking water compositions to provide methods for increasing water consumption by an animal or improving hydration for an animal. Kits comprising combinations of flavored drinking water additives, vitamins, minerals, functional ingredients, and devices useful for promoting the health or wellness of an adult animal are also provided.

Additional objects, features, and advantages of the invention will be readily apparent to those skilled in the art.

### DETAILED DESCRIPTION OF THE INVENTION

### Definitions

The term “animal” means a human or other animal that could enjoy flavored drinking water and possibly benefit from improved hydration that results from drinking more water, including avian, bovine, canine, equine, feline, hicrine, murine, ovine, and porcine animals.

The term “companion animal” means domesticated animals such as cats, dogs, birds, rabbits, guinea pigs, ferrets, hamsters, mice, gerbils, horses, cows, goats, sheep, donkeys, pigs, and the like.

The term “functional ingredient” means an ingredient having various health benefits such as antioxidants, bioactive peptides, soluble fiber, immunostimulants, essential fatty acids, etc.

The term “single package” means that the components of a kit are physically associated in or with one or more containers and considered a unit for manufacture, distribution, sale, or use. Containers include, but are not limited to, bags, boxes, cartons, bottles, packages of any type or design or material, over-wrap, shrink-wrap, affixed components (e.g., stapled, adhered, or the like), or combinations thereof. A single package may be containers of individual flavored drinking water additives physically associated such that they are considered a unit for manufacture, distribution, sale, or use.

The term “virtual package” means that the components of a kit are associated by directions on one or more physical or virtual kit components instructing the user how to obtain the other components, e.g., a bag or other container containing one component and directions instructing the user to go to a website, contact a recorded message or a fax-back service, view a visual message, or contact a caregiver or instructor to obtain instructions on how to use the kit or safety or technical information about one or more components of a kit.

The term “about” means plus or minus 20%, preferably plus or minus 10%, more preferably plus or minus 5%, most preferably plus or minus 2%.

All percentages expressed herein are by weight of the total weight of the composition unless expressed otherwise.

As used herein, ranges encompass each and every value within the range and are used to avoid having to list each and every value within the range. Any appropriate value within the range can be selected, where appropriate, as the upper value, lower value, or terminus of the range.

The invention is not limited to the particular methodology, protocols, and reagents described herein because they may vary. Further, the terminology used herein is for the purpose of describing particular embodiments only and is not intended to limit the scope of the invention.

As used herein, the singular form of a word includes the plural, and vice versa, unless the context clearly dictates otherwise. Thus, the references “a”, “an”, and “the” are generally inclusive of the plurals of the respective terms. For example, reference to “flavored drinking water additive” or “a method” includes a plurality of such “flavored drinking water additives” or “method.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

Unless defined otherwise, all technical and scientific terms and any acronyms used herein have the same meanings as commonly understood by one of ordinary skill in the art in the field of the invention. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, and other references cited or referred to herein are incorporated herein by reference to the extent allowed by law. The discussion of those references is intended merely to summarize the assertions made therein. No admission is made that any such patents, patent applications, publications or references, or any portion thereof, are relevant prior art for the present invention and the right to challenge the accuracy and pertinence of such patents, patent applications, publications, and other references is specifically reserved.

### The Invention

In one aspect, the invention provides flavored drinking water additives suitable for consumption by animals. The flavored drinking water additive comprising from about 5 to about 100% by weight of one or more pyrophosphate salts, preferably from about 10 to about 60%, more preferably from about 20 to about 40%. The pyrophosphate salts useful in the present compositions include the dialkali metal pyrophosphate salts, tetraalkali metal pyrophosphate salts, and mixtures thereof. In one embodiment, the pyrophosphate salt is sodium acid pyrophosphate (Na₂H₂P₂O₇), tetrasodium pyrophosphate (Na₄P₂O₇), tetrapotassium pyrophosphate (K₄P₂O₇), or combinations thereof. In a preferred embodiment, the pyrophosphate salt is sodium acid pyrophosphate. In some embodiments, the pyrophosphate salt has a particle size of about less than 3 mm, preferably 2 mm, more preferably 1 mm. In some embodiments, the pyrophosphate salt is a dry powder. In another embodiment, the pyrophosphate salt is in a solution.

In another aspect, the invention provides flavored drinking water compositions suitable for consumption by animals. The flavored drinking water compositions comprise one or more pyrophosphate salts and water. In one embodiment, the pyrophosphate salt is sodium acid pyrophosphate, tetrasodium pyrophosphate, tetrapotassium pyrophosphate, or combinations thereof. In a preferred embodiment, the pyrophosphate salt is sodium acid pyrophosphate. In one embodiment, the flavored drinking water composition comprises from about 0.05 to about 10% one or more pyrophosphate salts, preferably from about 0.08 to about 2%, more preferably from about 0.1 to about 1%.

The flavored drinking water additives and flavored drinking water compositions of the present invention may further comprise vitamins, minerals, functional ingredients, or combinations thereof. Suitable vitamins, minerals, and functional ingredients include, but are not limited to, Taurine, Ferrous Sulfate, Zinc Sulfate, Niacin, Vitamin E Supplement, Manganese Sulfate, Copper Sulfate, Calcium Pantothenate, Thiamine Mononitrate, Pyridoxine Hydrochloride, Potassium Iodide, Vitamin A Supplement, Folic Acid, Sodium Selenite, Biotin, Vitamin B-12 Supplement, Vitamin D-3 Supplement.

In another aspect, the invention provides methods for increasing water consumption by an animal. The methods comprise administering to animals a composition comprising water and one or more pyrophosphate salts. In some embodiment, the pyrophosphate salt is sodium acid pyrophosphate, tetrasodium pyrophosphate, tetrapotassium pyrophosphate, or combinations thereof. In a preferred embodiment, the pyrophosphate salt is sodium acid pyrophosphate.

In another aspect, the invention provides methods for improving hydration for an animal. The methods comprise administering to the animal composition comprising water and one or more pyrophosphate salts. In some embodiment, the pyrophosphate salt is sodium acid pyrophosphate, tetrasodium pyrophosphate, tetrapotassium pyrophosphate, or combinations thereof. In a preferred embodiment, the pyrophosphate salt is sodium acid pyrophosphate.

In some embodiments, the animal is a companion animal. In a preferred embodiment, the animal is a feline, preferably a cat.

In a further aspect, the invention provides a package suitable for containing flavored drinking water additives or flavored drinking water compositions. The package comprises at least one material suitable for containing flavored drinking water additives or flavored drinking water compositions and a label affixed to the package containing a word or words, picture, design, acronym, slogan, phrase, or other device, or combination thereof that indicates that the contents of the package contains flavored drinking water additives or flavored drinking water compositions. In another embodiments, the label affixed to the package contains a word or words, picture, design, acronym, slogan, phrase, or other device, or combination thereof that indicates that the contents of the package contains flavored drinking water compositions with beneficial properties relating to increasing water consumption or improving hydration. In another embodiment, the package further comprises at least one window. In another embodiment, the package further comprises flavored drinking water additives. In another embodiment, the package further comprises flavored drinking water compositions.

In a further aspect, the invention provides kits suitable for administering a flavored drinking water composition to an animal. The kits comprise in separate containers in a single package or in separate containers in a virtual package, as appropriate for the kit component, in separate containers in a single package or in separate containers in a virtual package, as appropriate for the kit component, flavored drinking water additive and one or more of (1) a container of water; (2) one or more ingredients suitable for consumption by an animal; (3) one or more vitamins, minerals, or functional ingredients; (4) one or more mixing devices; (5) instructions for how to combine flavored drinking water additives and other kit components to produce a composition useful for increasing water consumption and improving hydration; (3) instructions for how to use flavored drinking water additives for increasing water consumption and improving hydration; and (4) a device for administering the combined or prepared kit components to an animal.

When the kit comprises a virtual package, the kit is limited to instructions in a virtual environment in combination with one or more physical kit components. The kit contains flavored drinking water additives or flavored drinking water compositions and other components in amounts sufficient to increase water consumption by an animal or improve hydration for an animal. Typically, flavored drinking water additives and flavored drinking water compositions and the other suitable kit components are admixed just prior to consumption by an animal. The kits may contain the kit components in any of various combinations and/or mixtures. In one embodiment, the kit contains a packet containing one or more flavored drinking water additive and a container of water for consumption by an animal. The kit may contain additional items such as a device for mixing the flavored drinking water additives and ingredients or a device for containing the admixture, e.g., a food bowl. In another embodiment, the flavored drinking water additives are mixed with additional nutritional supplements such as vitamins and minerals that promote good health in an animal. In one embodiment, the flavored drinking water additives are in a sachet.

The compositions, methods, and kits are useful for increasing water consumption by an animal and improving hydration for animals.

In another aspect, the invention provides a means for communicating information about or instructions for one or more of (1) using flavored drinking water additives to prepare a flavored drinking water composition; (2) using flavored drinking water compositions for increasing water consumption or improving hydration for an animal; (3) contact information for consumers to use if they have a question regarding the methods and compositions of the invention; and (4) nutritional information about flavored drinking water additives. The means comprises a document, digital storage media, optical storage media, audio presentation, or visual display containing the information or instructions. In certain embodiments, the communication means is a displayed web site, visual display, kiosk, brochure, product label, package insert, advertisement, handout, public announcement, audiotape, videotape, DVD, CD-ROM, computer readable chip, computer readable card, computer readable disk, computer memory, or combination thereof containing such information or instructions. Useful information includes one or more of (1) methods and techniques for combining flavored drinking water additives and/or other components and (2) methods and techniques for administering flavored drinking water compositions; (3) contact information for consumers to use if they have a question about the invention and its use. Useful instructions include amounts for mixing and administration amounts and frequency. The communication means is useful for instructing on the benefits of using the present invention and communicating the approved methods for administering the invention to an animal.

### EXAMPLES

The invention can be further illustrated by the following examples, although it will be understood that these examples are included merely for purposes of illustration and are not intended to limit the scope of the invention unless otherwise specifically indicated.

### Example 1

Four (4) flavored water additives (labeled A1, A2, A3, and A4) were made by blending and mixing the dry ingredients shown in Tables 1 through 4. All additives were soluble in water at the ambient temperature (23° C.).

TABLE 1

| | Example |
|---|---|
| | A1 |
| Ingredient | wt. % |
| Tetrasodium Pyrophosphate | 100.00 |
| Total | 100.00 |

TABLE 2

| | Example |
|---|---|
| | A2 |
| Ingredient | wt. % |
| Sodium Acid Pyrophosphate | 100.00 |
| Total | 100.00 |

TABLE 3

| | Example |
|---|---|
| | A3 |
| Ingredient | wt. % |
| Tetrapotassium Pyrophosphate | 100.00 |
| Total | 100.00 |

TABLE 4

| | Example |
|---|---|
| | A4 |
| Ingredient | wt. % |
| Tetrasodium Pyrophosphate | 25.60 |
| Sodium Chloride | 74.40 |
| Total | 100.00 |

### Example 2

Four (4) flavored water drinks (labeled B1, B2, B3, and B4; referred to as a group as “test drinks”) were made by dissolving the flavored water additives in tap water in the amounts shown in Table 5. Saline was used as a control.

TABLE 5

| Flavored | Water Additive Dosage, g/100 g | Water |
|---|---|---|
| Water | Water | Additive |
| B1 | 0.100 | A1 |
| B2 | 0.126 | A2 |
| B3 | 0.100 | A3 |
| B4 | 0.390 | A4 |
| Saline | 0.290 | Salt |

A group of sixty (60) cats were offered the test drinks and the control at the same time for a period of four (4) hours. A two-bowl feeding test methodology was used. The drinks were randomized with the test drinks and control drink placed on the right-side bowl or left-side bowl. Standard dry cat food was also provided to simulate a home water consumption environment. At the end of the 4 hour period, drinking amounts of each cat for the test drinks and control drink were recorded. Consumption % was calculated as the ratio of drinking amount for one drink over drinking total amount for two drinks. Individual animal consumption data were then averaged to determine the average consumption %. Statistical analysis was performed and p-values for the difference between the test drinks and the control were calculated. The results from six (6) repeats of the experiment are shown in Table 6.

TABLE 6

| | | | Total Avg. |
|---|---|---|---|
| | | | Water |
| Pal. Test | Average Consumption, % | p-value | Consumption |
| B1 vs. Tap | 65 vs. 35 | <0.05 | 58 g |
| Water | | | |
| B2 vs. Tap | 74 vs. 26 | <0.05 | 72 g |
| Water | | | |
| B3 vs. Tap | 67 vs. 33 | <0.05 | 64 g |
| Water | | | |

### Example 3

A group of sixty (60) cats were offered a test drink and a different test drink the same time for a period of four (4) hours. The experimental procedure in Example 2 was repeated. The results from three (3) repeats of the experiment are shown in Table 7.

TABLE 7

| | | | Total Avg. |
|---|---|---|---|
| | | | Water |
| Pal. Test | Average Consumption, % | p-value | Consumption |
| B4 vs. Saline | 82 vs. 18 | <0.01 | 61 g |
| B2 vs. B1 | 64 vs. 36 | <0.05 | 70 g |

### Example 4

Example 3 was repeated using the saline control and tap water without added saline. The results are shown in Table 8.

TABLE 8

| | | | Total Avg. |
|---|---|---|---|
| | Average | | Water |
| Pal. Test | Consumption, % | p-value | Consumption |
| Saline vs. Tap | 49 vs. 51 | n.s. | 38 g |
| Water | | | |

Referring to the Table 6, the results show that cats had significantly higher consumption of flavored water drinks (test drinks). All p-values are less than 0.05, which indicates the palatability difference between the flavored water drinks and the control drink was statistically significant. Referring to Table 7, the results show that cats had significantly higher consumption of flavored drink B4 presented in saline than from saline alone; and that cats had a higher consumption of flavored drink B2 than B1. Referring to Table 8, the results show that cats had equal consumption when they were presented with Saline and Tap Water at the same time.

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims the invention may be practiced otherwise than as specifically described.

What is claimed is:

1. A flavored drinking water additive comprising from about 5 to about 100% by weight of one or more pyrophosphate salts.

2. The flavored drinking water additive of claim 1 wherein the pyrophosphate salt is sodium acid pyrophosphate, tetrasodium pyrophosphate, tetrapotassium pyrophosphate, or combinations thereof.

3. The flavored drinking water additive of claim 1 wherein the pyrophosphate salt has a particle size of about less than 3 mm.

4. The flavored drinking water additive of claim 1 wherein the pyrophosphate salt is a dry powder.

5. The flavored drinking water additive of claim 1 wherein the pyrophosphate salt is sodium acid pyrophosphate.

6. A flavored drinking water composition comprising one or more pyrophosphate salts and water.

7. The composition of claim 6 wherein the pyrophosphate salt is sodium acid pyrophosphate, tetrasodium pyrophosphate, tetrapotassium pyrophosphate, or combinations thereof.

8. The composition of claim 6 comprising from about 0.05 to about 10% one or more pyrophosphate salts.

9. The composition of claim 6 wherein the pyrophosphate salt is sodium acid pyrophosphate.

10. The composition of claim 6 further comprising one or more vitamins, minerals, functional ingredients or combinations thereof.

11. The composition of claim 10 wherein the vitamins, minerals, functional ingredients, or combinations thereof are one or more of Taurine, Ferrous Sulfate, Zinc Sulfate, Niacin, Vitamin E Supplement, Manganese Sulfate, Copper Sulfate, Calcium Pantothenate, Thiamine Mononitrate, Pyridoxine Hydrochloride, Potassium Iodide, Vitamin A Supplement, Folic Acid, Sodium Selenite, Biotin, Vitamin B-12 Supplement, Vitamin D-3 Supplement.

12. A method for increasing water consumption by an animal comprising administering to the animal a composition comprising water and one or more pyrophosphate salts.

13. The method of claim 12 wherein the pyrophosphate salt is sodium acid pyrophosphate, tetrasodium pyrophosphate, tetrapotassium pyrophosphate, or combinations thereof.

14. The method of claim 12 wherein the animal is a feline.

15. A method for improving hydration for an animal comprising administering to the animal a composition comprising water and one or more pyrophosphate salts.

16. The method of claim 15 wherein the pyrophosphate salt is sodium acid pyrophosphate, tetrasodium pyrophosphate, tetrapotassium pyrophosphate, or combinations thereof.

17. The method of claim 15 wherein the animal is a feline.
